(19) United States
(12) Patent Application Publication
(10) Pub. No.: US 2008/0087479 A1
(43) Pub. Date: Apr. 17, 2008

(54) Power system of hybrid fuel cell bus and control method thereof

(75) Inventor: Ho Sung Kang, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/650,251

(22) Filed: Jan. 4, 2007

(30) Foreign Application Priority Data
Oct. 11, 2006 (KR) 10-2006-0099024

(51) Int. Cl. B60L 11/18; H01M 16/00

(52) U.S. Cl. 180/65.3; 429/9; 429/13

(57) ABSTRACT

The present invention provides a power system of a hybrid fuel cell bus, comprising: a first auxiliary battery supplying electric power to first electric parts designed for operation of a fuel cell vehicle; a second auxiliary battery supplying electric power to second electric parts designed for operation of an internal combustion engine vehicle; and a stack starting part electrically connected to one of the first and the second auxiliary batteries for operating the fuel cell stack.

### CROSS-REFERENCE TO RELATED APPLICATION

This application claims priority to and the benefit of Korean Patent Application No. 10-2006-0099024 filed in the Korean Intellectual Property Office on Oct. 11, 2006, the entire contents of which are incorporated herein by reference.

### BACKGROUND OF THE INVENTION

(a) Field of the Invention

The present invention relates to a power system of a hybrid fuel cell bus and a control method thereof. More particularly, it relates to a power system of a hybrid fuel cell bus using a fuel cell and a super capacitor connected to the fuel cell, and a control method thereof.

(b) Background

A fuel cell is an electrochemical energy conversion device. A fuel cell is extremely interesting to people because it offers a means of making power more efficiently and less emissions.

A fuel cell converts the chemicals hydrogen and oxygen to water, and in the process it produces electricity. It comprises an anode, a cathode, electrolyte, and a catalyst. An the anode, hydrogen gas is decomposed into hydrogen protons and electrons. Hydrogen proton passes an electrolyte to move to the cathode and reacts with oxygen together with an electron supplied from an external circuit at the cathode so as to generate water. The electron flow through the external circuit is used as electric power.

Most fuel cell vehicles are hybrid vehicles, which use an energy storage device such as a high voltage battery or a super capacitor together with a fuel cell. Since the super capacitor has various advantages, it has been widely used.

In addition, a fuel cell vehicle is provided with a low voltage auxiliary battery as an auxiliary power source. The auxiliary battery supplies energy to vehicle starting parts. In order for the fuel cell to produce electric power, a fuel supply system such as hydrogen and oxygen supply systems and various controllers should be operated in advance.

The hybrid fuel cell systems have been developed mainly for small size vehicles such as a passenger car. Hybrid fuel cell systems for a large vehicle requiring high output power such as a bus have not been developed until recent years.

For the conventional fuel cell vehicles or conventional hybrid fuel cell vehicles developed for a small vehicle, electric parts necessary for the operation of the fuel cell are designed to be able to use a 12V auxiliary battery (by automatic voltage criteria) and also the control logics of various controllers are fitted to the same.

On the other hand, conventional internal combustion engine buses use a 24V auxiliary battery (by automatic voltage criteria) and various electric parts thereof are designed to use the 24V auxiliary battery.

Accordingly, in order to develop a hybrid fuel cell bus, redesigning various electric parts as well as fuel cell systems is required. In particular, 12V electric parts used in the fuel cell vehicle should be redesigned or 24V electric parts used in a conventional internal combustion engine bus should be changed.

### SUMMARY OF THE INVENTION

The present invention has been made in an effort to provide a power system of a hybrid fuel cell bus and a control method thereof having advantages of minimizing design change in various parts designed for different battery voltages.

Also, the present invention has been made in an effort to provide a power system of a hybrid fuel cell bus and a control method thereof having advantages of capable of using 12V electric parts of a conventional fuel cell vehicle and 24V electric parts of a conventional internal combustion engine bus, thereby minimizing time and costs for developing a hybrid fuel cell bus system.

Furthermore, the present invention has been made in an effort to provide a power system of a hybrid fuel cell bus and a control method thereof having advantages of effectively operating a hybrid system of a super capacitor and a fuel cell.

In one aspect, the present invention provides a power system of a hybrid fuel cell bus comprising: a fuel cell stack; a super capacitor connected to the fuel cell stack; a traction motor supplied with electric power from the fuel cell stack or from both the fuel cell stack and the super capacitor so as to drive a vehicle, and supplying electric power generated by regenerative braking to the supper capacitor; a motor control unit controlling an electric power input to the traction motor and an electric power output from the traction motor; a first auxiliary battery supplying electric power to first electric parts designed for operation of a fuel cell vehicle; a second auxiliary battery supplying electric power to second electric parts designed for operation of an internal combustion engine vehicle; and a stack starting part electrically connected to one of the first and the second auxiliary batteries for operating the fuel cell stack.

Preferably, the first auxiliary battery may be a 12V auxiliary battery and the second auxiliary battery may be a 24V auxiliary battery.

In a preferred embodiment, the stack starting part may be designed to be supplied with electric power from the first auxiliary battery before starting of the fuel cell stack and supplied with electric power from the fuel cell stack after starting of the fuel cell stack.

Suitably, preferred power systems according to the present invention may further comprise: a first DC/DC converter between the first auxiliary battery and the stack starting part for converting voltage of the first auxiliary battery to voltage of the stack starting part; and a high voltage DC/DC converter between the fuel cell stack and the stack starting part for converting voltage of the fuel cell stack to voltage of the stack starting part, wherein the high voltage DC/DC converter is electrically connected to the first DC/DC converter such that the voltage converted by the high voltage DC/DC converter is supplied to the first DC/DC converter.

Preferably, the fuel cell stack may generate DC voltage of 900V

Also preferably, the driving voltage of the stack starting part may be 350V.

In another preferred embodiment, a second DC/DC converter may be provided in a connection between the fuel cell stack and the second auxiliary battery so as to charge the second auxiliary battery using electric power of the fuel cell stack.

In still another preferred embodiment, an inverter may be electrically connected to the fuel cell stack for being supplied with electric power of the fuel cell stack to drive an auxiliary component.

In such embodiment, the auxiliary component may include at least one of a water pump, a power steering pump, and an air conditioner compressor.

Another preferred power systems may further comprise a power line electrically connecting the fuel cell stack and the traction motor and a power line passing through a chopper and a braking resistance provided in a power line connecting the super capacitor.

Preferably, such power lines may be configured such that electrical energy supplied to the super capacitor is exhausted when the super capacitor is over-charged and electric power regenerated by the traction motor is charged to the super capacitor when the super capacitor is not over-charged.

In another aspect, the present invention provides a control method of a power system of a hybrid fuel cell bus, comprising the steps of: (a) converting a low voltage of a first auxiliary battery to a driving voltage of a stack starting part; (b) driving the stack staring part by the driving voltage of the stack starting part; (c) operating a fuel cell stack by an operation of the stack starting part; (d) generating a high voltage power by an operation of the fuel cell stack; (e) switching an electric power supply passage to the stack starting part so as to convert the high voltage power to the voltage of the stack starting part, and supplying the converted voltage to the stack starting part; (f) supplying the high voltage power to a traction motor; (g) converting the high voltage power to the voltage of the first auxiliary battery; and (h) charging a super capacitor with the high voltage power.

Preferably, the first (a) may further comprise a step where the first auxiliary battery supplies electric power to first electric parts designed for operation of a fuel cell vehicle and the second auxiliary battery supplies electric power to second electric parts designed for operation of an internal combustion engine vehicle.

More preferably, the first auxiliary battery may be a 12V auxiliary battery and the second auxiliary battery may be a 24V auxiliary battery.

Also preferably, the step (a) and the step (g) may use the same DC/DC converter.

The step (e) may convert 900V to 350V.

In a preferred embodiment, the step (e) or the step (f) may further comprise a step of converting the high voltage power generated by the fuel cell stack to a low voltage so as to charge the second auxiliary battery.

In such embodiment, the step (g) may further comprise a step of supplying the high voltage power to an inverter of an auxiliary component.

Another preferred control methods of the present invention may further comprise a step of performing a driving mode after the step (h). The driving mode may be the one selected from the group consisting of: (i) a normal driving mode which comprises the steps of: converting high voltage of the fuel cell stack to driving voltage of the stack starting part; and supplying the high voltage to the traction motor and the inverter; (ii) an acceleration or hill climbing mode which comprises the steps of: converting high voltage of the fuel cell stack to driving voltage of the stack starting part; supplying the high voltage to the traction motor and the inverter; and supplying charge electric power of the super capacitor to the traction motor; and (iii) a regenerative braking mode which comprises the steps of: generating regenerative electric power by regenerative braking of the traction motor; converting the regenerative electric power to the driving voltage of the stack starting part; supplying the regenerative electric power to an inverter; determining whether the super capacitor has been over charged; exhausting electrical energy supplied to the super capacitor in the case that the super capacitor is over-charged; and charging the super capacitor by the regenerative electric power in the case that the super capacitor is not over-charged.

In another aspect, motor vehicles are provided that comprise a described power system.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present power systems will be particularly useful with a wide variety of motor vehicles.

Other aspects of the invention are discussed infra.

### BRIEF DESCRIPTION OF THE DRAWINGS

FIG. 1 is a diagram of a power system of a hybrid fuel cell bus according to an exemplary embodiment of the present invention.

FIG. 2 is a flow chart for explaining a starting mode in a control method of a power system of a hybrid fuel cell bus according to an exemplary embodiment of the present invention.

FIG. 3A to FIG. 3D are drawings showing electric power flow of a power system of a hybrid fuel cell bus according to an exemplary embodiment of the present invention.

FIG. 4 is a flow chart showing a driving mode in a power system of a hybrid fuel cell bus according to an exemplary embodiment of the present invention.

FIG. 5A is a drawing showing electric power flow in a state that a hybrid fuel cell bus is in a normal driving mode.

FIG. 5B is a drawing showing electric power flow of a power system of a hybrid fuel cell bus in a state that a hybrid fuel cell bus is in an acceleration mode or in a hill-climbing mode.

FIG. 5C is a drawing showing electric power flow of a power system of a hybrid fuel cell bus in a state that charge of a super capacitor is performed in a regenerative braking mode in which a regenerative braking occurs in a hybrid fuel cell bus.

FIG. 5D is a drawing showing electric power flow a power system of a hybrid fuel cell bus in a state that over charge of a super capacitor occurs in a regenerative braking mode in which a regenerative braking occurs in a hybrid fuel cell bus.

FIG. 6A is a drawing showing that the supper capacitor is charged using a chopper and a braking resistance.

FIG. 6B is a drawing showing electric power flow when energy is exhausted by braking resistance in the regenerative braking mode shown in FIG. 5D.

### DETAILED DESCRIPTION

Reference will now be made in detail to the preferred embodiment of the present invention, wherein like reference numerals refer to like elements throughout. The embodiments are described below so as to explain the present invention by referring to the figures.

In one aspect, as discussed above, the present invention provides a power system of a hybrid fuel cell bus.

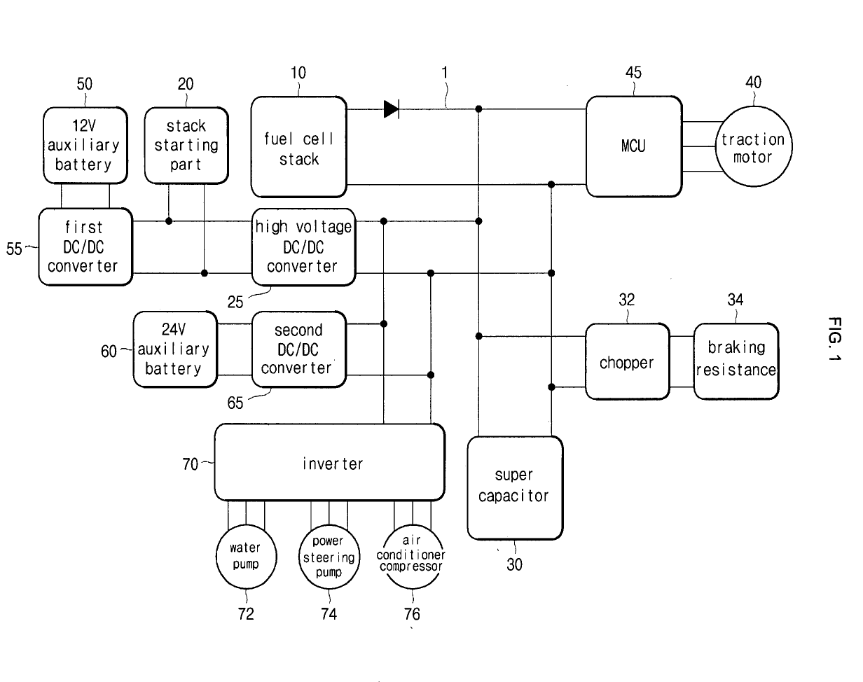

FIG. 1 is a diagram of a power system of a hybrid fuel cell bus according to an exemplary embodiment of the present invention.

Referring to FIG. 1, such power system includes a fuel cell stack 10.

The fuel cell stack 10 supplies a high voltage power of about 900V to a DC power line 1 of a bus.

In order for the fuel cell stack 10 to be operated normally so as to build up a high voltage power of about 900V, stack starting parts 20 serving to start a fuel cell stack such as a hydrogen supply device, an air or oxygen supply device, a cooling device, etc should be operated in advance.

The stack starting parts 20 are configured to be connected to the DC power line 1 of a bus so as to be supplied with power from the fuel cell stack 10 after the staring of the fuel cell stack 10, and is supplied with electric power from a 12V auxiliary battery 50 before the starting of the fuel cell stack 10 so as to start.

Preferably, the present power system of a hybrid fuel cell bus further includes a super capacitor 30 as an energy storage device.

The super capacitor 30 is electrically connected to the DC power line 1 of a bus so as to store energy supplied from the fuel cell stack 10.

The super capacitor 30 serves as an assist power source such that energy stored in the super capacitor 30 is supplied to a traction motor 40 in the case that the traction motor 40 operates under high load, for example, in the case that a fuel cell bus is accelerated or climbs a hill.

The super capacitor 30 is connected to the fuel cell stack 10 in parallel, and is charged so as to add power assist to the traction motor 40. The super capacitor 30 starts to be charged after high voltage of 900V is established after the starting of the fuel cell stack 10.

A power line to which a chopper 32 and a braking resistance 34 are connected is provided in an electrical connection between the super capacitor 30 and the fuel cell stack 10. Accordingly, a motor control unit 45 is connected to the fuel cell stack 10 and the super capacitor 30 respectively by power lines without or with the chopper 32 and the braking resistance 34, so that electric power flow passages can be controlled depending on operating modes.

When the super capacitor 30 is charged with electric power generated by the fuel cell stack 10, the chopper 32 and the braking resistance 34 serve to prevent energy of the fuel cell stack 10 from being rapidly supplied to the super capacitor 30, thereby preventing occurrence of shutdown of the fuel cell stack 10 or damage to the super capacitor 30.

A power system of a hybrid fuel cell bus according to an exemplary embodiment of the present invention also comprises the traction motor 40 as a driving power source.

The traction motor 40 is supplied with energy from the fuel cell stack 10 or from both the fuel cell stack 10 and the super capacitor 30 to drive a vehicle.

The present power system of a hybrid fuel cell bus also comprises the motor control unit, i.e., the MCU 45 for controlling operation of the traction motor 40.

The MCU 45 controls the power of the fuel cell stack 10 to be supplied to the traction motor 40 when the fuel cell stack 10 normally operates after being started, i.e., when it becomes a state of being able to supply high voltage power of 900V.

The traction motor 40 uses DC or AC electric power, and the motor in an embodiment of the present invention is realized by a three-phase motor using AC electric power. The MCU 45 includes an inverter (not shown) that converts DC electric power to AC electric power such that the motor can be driven by the DC electric power of 900V supplied by the fuel cell stack 10.

In addition, according to an exemplary embodiment of the present invention, the traction motor 40 performs regenerative braking during the braking of a vehicle so as to operate as a generator to produce electric power, and supplies this electric power to the DC power line 1 of a bus.

Electric power generated by the regenerative braking of the traction motor 40, i.e., regenerative power, is supplied as driving energy of an inverter 70 of auxiliary components and the stack starting parts 20 and storage energy of the super capacitor 30. For this, an inverter inside the MCU 45 changes its power converting direction so as to convert AC electric power of the traction motor to DC electric power and then supply the converted power to the DC power line 1. It includes parts (not shown) for establishing energy by the regenerative braking to 900V. As such, the MCU 45 controls the traction motor 40 by controlling power input and power output to and from the traction motor 40.

Preferably, a power system of a hybrid fuel cell bus according to an exemplary embodiment of the present invention is provided with the 12V auxiliary battery 50 and a 24V auxiliary battery 60 as two low voltage auxiliary batteries so as to drive 12V electric parts (not shown) and 24V electric parts (not shown) installed to a hybrid fuel cell bus.

The 12V auxiliary battery 50 is a low voltage battery installed to a passenger vehicle, and the 24V auxiliary battery is a low voltage battery installed to an internal combustion engine bus.

The 12V electric parts include parts of a conventional fuel cell vehicle (including a hybrid fuel cell vehicle), and refer to electric parts which can be commonly used in various fuel cell vehicles using a fuel cell as a power source in addition to a hybrid fuel cell bus according to an exemplary embodiment of the present invention. The 12V electric parts are referred to as first electric parts for a distinction from the 24V electric parts. The 12V electric parts include various controllers such as a fuel cell stack controller, a traction motor controller, and a vehicle controller.

The 24V electric parts include parts of an internal combustion engine bus. Accordingly, the 24V electric parts refer to electric parts which can be commonly used in a hybrid fuel cell bus and an internal combustion engine bus. The 24V electric parts are referred to as second electric parts for a distinction from the 12V electric parts. The 24V electric parts include electric parts of a general internal combustion engine bus such as a radiator fan, a radio, a headlamp, an electric driving apparatus for opening/closing door, etc.

In an exemplary embodiment of the present invention, the 12V auxiliary battery 50 drives the stack starting parts 20.

The 12V auxiliary battery 50 supplies electric power to controllers of the stack starting parts, and at the same time is used as a power source for driving the stack starting parts 20 before establishing 900V in the fuel cell stack 10 in an initial starting mode.

The stack starting parts 20 are designed to use 350V electric power as driving electric power. Accordingly, a first DC/DC converter 55 converting voltage of the 12V auxiliary battery 50 to 350V which is driving voltage of the stack starting parts 20 is connected to a DC power line between the stack starting parts 20 and the 12V auxiliary battery 50.

In addition, in order that the stack starting parts 20 are supplied with electric power from the fuel cell stack 10 after 900V is established by the normal operation of the fuel cell stack 10, a high voltage DC/DC converter 25 converting 900V to 350V is connected to a power line between the stack starting parts 20 and the fuel cell stack 10.

After the fuel cell stack 10 is started, electric power of the fuel cell stack is supplied to the 12V auxiliary battery 50 through the DC power line so as to charge the 12V auxiliary battery 50. At this time, electric power converted to 350V in the high voltage DC/DC converter 25 is converted to 12V auxiliary battery voltage by the first DC/DC converter 55 and is connected to the power line such that the 12V auxiliary battery 50 can be charged.

The first DC/DC converter 55 is designed to perform DC/DC converting in both directions; i.e., converting 12V auxiliary battery voltage to driving voltage of 350V of the stack starting parts 20 during the starting of a vehicle, and converting 350V electric power converted by the high voltage DC/DC converter to 12V auxiliary battery power and then supplying the converted power to the 12V auxiliary battery 50 after 900V of the fuel cell stack 10 is established.

In an exemplary embodiment of the present invention, the 24V auxiliary battery 60 is connected to the fuel cell stack 10 by the power line, and is configured to be charged by electric power generated by the fuel cell stack 10. For this, a second DC/DC converter 65 for converting 900V to 24V auxiliary battery voltage is connected to the power line connecting the 24V auxiliary battery 60 and the fuel cell stack 10. Accordingly, the 24V auxiliary battery 60 which has consumed electric power for driving 24V electric parts after the starting of the vehicle is charged after the normal operation of the fuel cell stack 10.

In a power system of a hybrid fuel cell bus according to an exemplary embodiment of the present invention, a power line is connected such that electric power of the fuel cell stack 10 is supplied to an auxiliary component as driving electric power thereof. The auxiliary component includes at least one of a water pump 72, a power steering pump 74, and an air conditioner compressor 76.

The hybrid fuel cell bus according to an exemplary embodiment of the present invention is designed to be able to share auxiliary components such as the water pump 72, the power steering pump 74, and the air conditioner compressor 76 with an internal combustion engine bus.

The inverter 70 converting electric power of the fuel cell stack 10 for this is provided. The inverter 70 controls the conversion of high voltage electric power of 900V of the fuel cell stack 10, and drives the water pump 72, the power steering pump 74, and the air conditioner compressor 76.

In another aspect, as discussed, the present invention provides a control method of a power system of a hybrid cell bus.

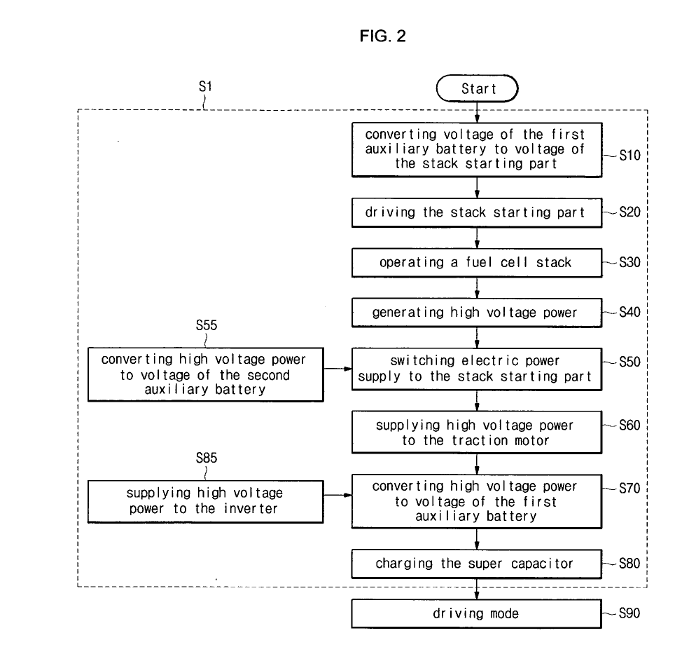

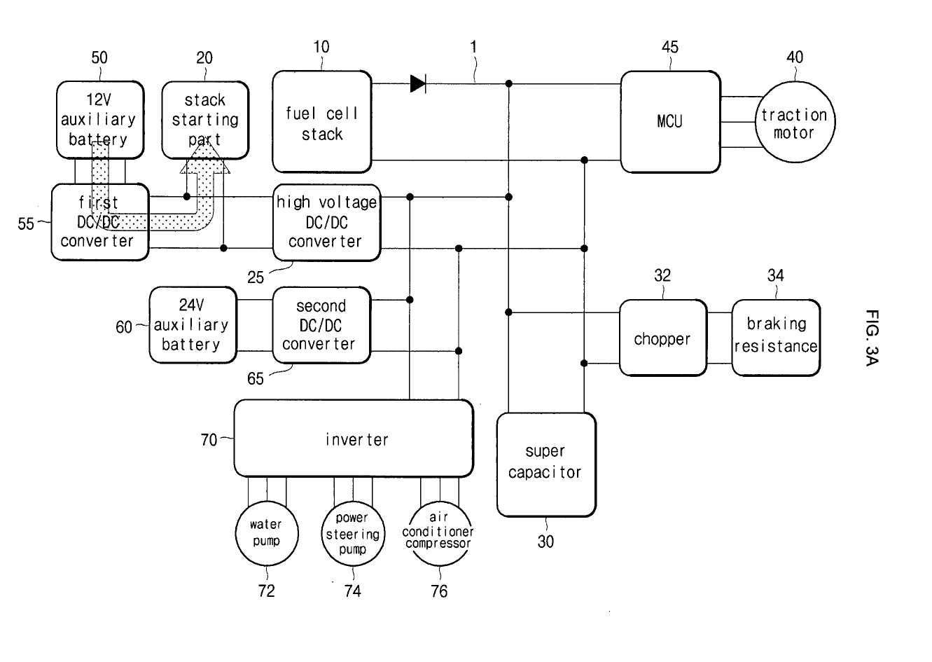

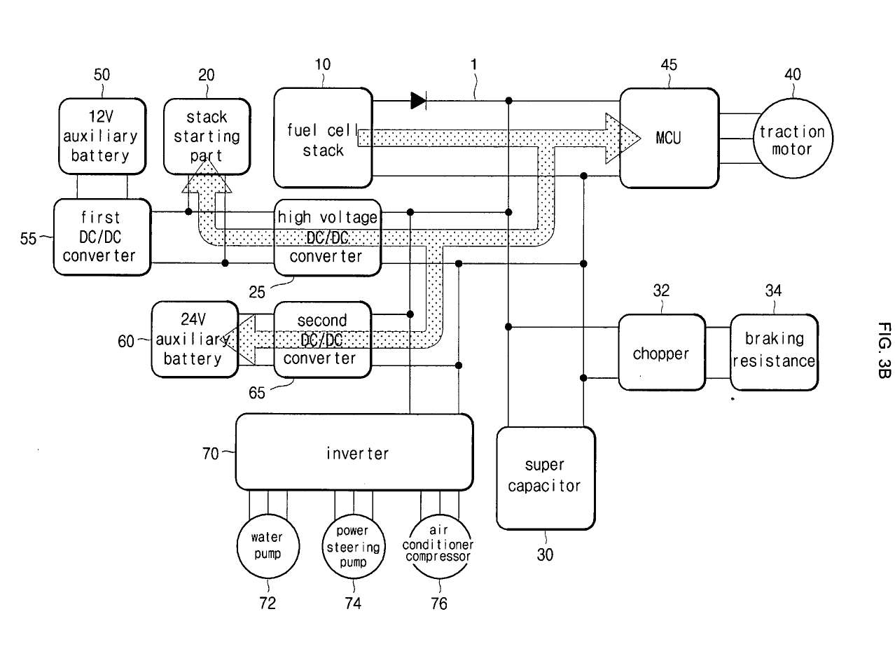

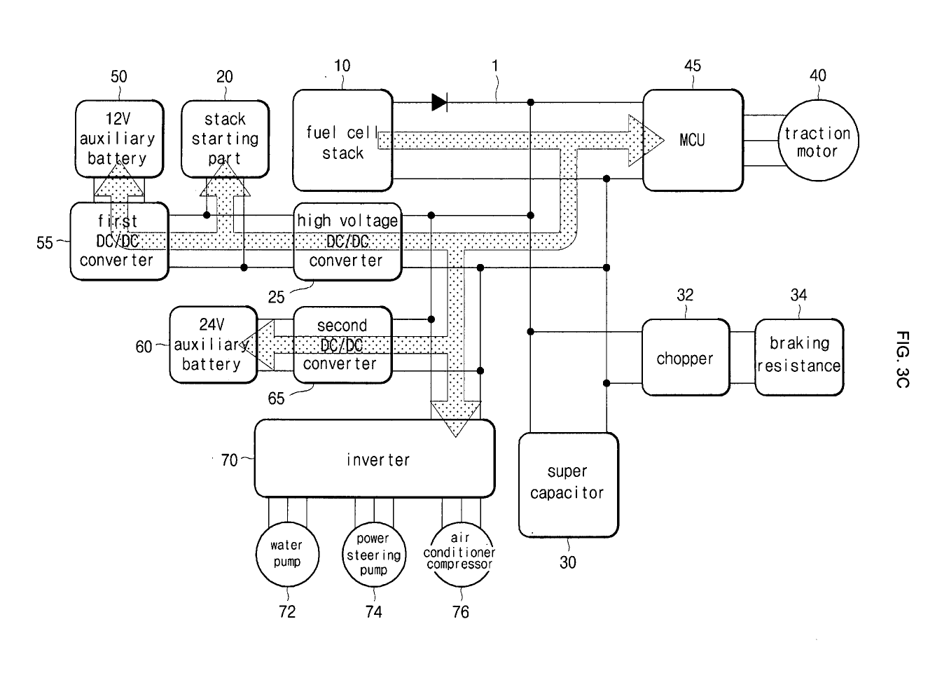

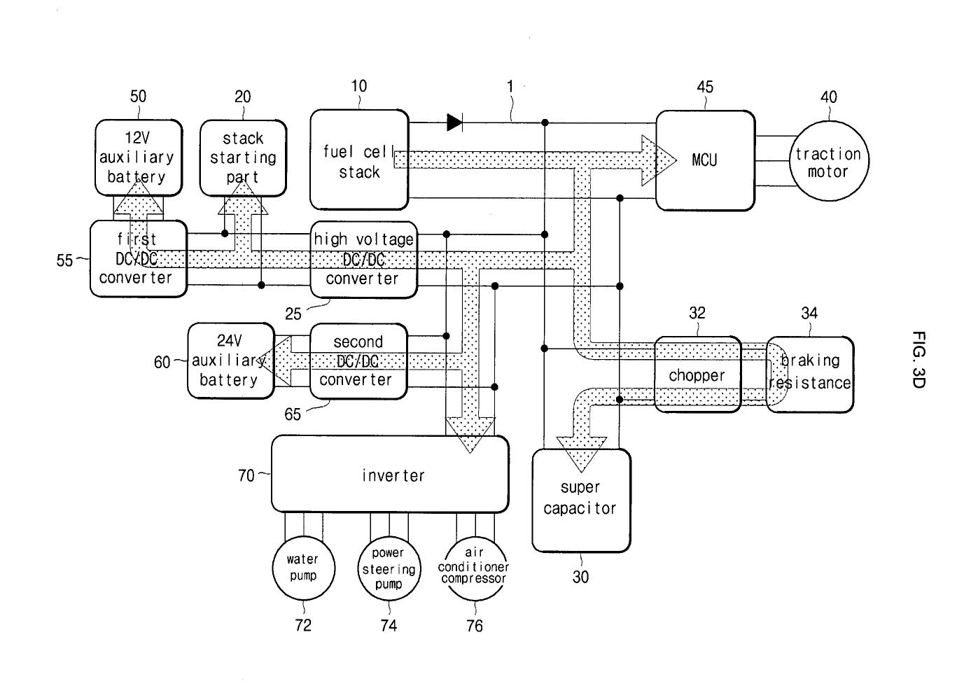

FIG. 2 is a flow chart for explaining a starting mode in a control method of a power system of a hybrid fuel cell bus according to an exemplary embodiment of the present invention, and FIG. 3A to FIG. 3D are drawings showing electric power flow of a power system of a hybrid fuel cell bus according to an exemplary embodiment of the present invention.

Referring to FIG. 2 to FIG. 3D, preferably, a control method of a power system of a hybrid fuel cell bus according to an exemplary embodiment of the present invention includes a starting mode S1 comprising: the step S10 of converting a low voltage of a first auxiliary battery to a driving voltage of the stack starting parts; the step S20 of driving the stack starting parts using the driving voltage of the stack starting parts; the step S30 of operating the fuel cell stack by the operation of the stack starting parts; the step S40 of generating a high voltage electric power by operation of the fuel cell stack; the step S50 of switching an electric power supply passage to the stack starting part, converting the high voltage electric power to stack starting part voltage, and supplying the converted voltage power to the stack starting part; the step S60 of supplying the high voltage electric power to the traction motor; the step S70 of converting the high voltage poser to the first auxiliary battery voltage; and the step S80 of charging the super capacitor with the high voltage electric power. Also preferably, the present control method may further a step S90 performing a hybrid driving mode.

As shown in FIG. 2 and FIG. 3A, if a vehicle key is turned to start the vehicle, a vehicle controller monitors various controllers such as a DC/DC converter and an inverter, and a vehicle starts to operate.

Firstly, in step S10, voltage of the 12V auxiliary battery is raised to 350V which is the driving voltage of the stack starting part. For this voltage increase, the first DC/DC converter 55 is connected between the 12V auxiliary battery 50 and the stack starting parts 20.

If a vehicle key is turned to start the vehicle, the first auxiliary battery 50 (i.e., the 12V auxiliary battery) and the second auxiliary battery 60 supply electric power to the first and the second electric parts, respectively. As described above, the first and the second electric parts include electric parts which can be shared with a fuel cell vehicle and electric part which can be shared with an internal combustion engine bus.

If a vehicle key is turned to start the vehicle, electric parts including various controllers which have started by the vehicle key are driven by electric power of the auxiliary battery, and electric power of the auxiliary battery is used by this operation.

Meanwhile, a control method of a power system of a hybrid fuel cell bus according to an exemplary embodiment of the present invention uses electric power of the 12V auxiliary battery as power source for driving the stack starting part.

Subsequently, in step S20, the stack starting parts 20, i.e., a hydrogen supply device, an oxygen or air supply device, a cooling device, etc are driven.

Referring to FIG. 2 and FIG. 3B, if the stack starting parts are driven, the fuel cell stack 10 is driven in step S30.

In step S40, the fuel cell stack 10 generates the high voltage power of about 900V, and applies the high voltage power to the DC power line of a bus.

The fuel cell stack 10 is operated so as to produce high voltage electric power, and in step S50, the electric power supply passage is switched to the stack starting part, so as to stop the voltage increase from the 12V auxiliary battery voltage to 350V. 900V applied to the DC power line is lowered to 350V by the high voltage DC/DC converter 25, and the lowered voltage is supplied to the stack starting part.

In step S60, the high voltage electric power is supplied to the traction motor 40 connected to the DC power line 1.

The traction motor 40 is supplied with the electric power of the fuel cell stack 10 by the control of the MCU 45. The MCU 45 includes an inverter. The MCU 45 converts the DC electric power supplied from the fuel cell stack 10 to AC electric power, and controls the operation of the traction motor 40 such that the vehicle is driven according to signals input from the vehicle controller.

Meanwhile, since the 24V electric parts which are electric parts shared with an internal combustion engine bus, i.e., the second electric parts use the electric power of the 24V auxiliary battery 60, it is necessary to charge the 24V auxiliary battery 60.

In step S50 or S60, a step S55 of operating the second DC/DC converter 65 supplied with 900V electric power through the DC power line connected to the fuel cell stack 10, lowering 900V to the voltage of the 24V auxiliary battery, i.e., the second auxiliary battery, and charging the 24V auxiliary battery 60.

Referring to FIG. 2 and FIG. 3C, in step S70, the first DC/DC converter 55 is turned to a charging mode, and 900V of high voltage of the fuel cell stack 10 is converted to charge the 12V auxiliary battery 50.

The step S80 includes a step of supplying high voltage power of the fuel cell stack 10 to the inverter 70 of the auxiliary components for operations thereof.

The first DC/DC converter 55 raises the voltage of the 12V auxiliary battery 50 to 350V and supplies the raised voltage to the stack starting parts 20 at an initial stage of the starting. If the electric power of the fuel cell stack 10 starts to be supplied to the stack starting parts 20 via the high voltage DC/DC converter 25, the first DC/DC converter 55 is turned to a charge mode in which 350V output of the high voltage DC/DC converter 25 is lowered to the voltage of the 12V auxiliary battery 50 and charging is then started.

In addition, the high voltage power of the fuel cell stack 10 starts to be supplied to the inverter 70 of the auxiliary components through the DC power line, so that auxiliary components such as the water pump 72, the power steering pump 74, and the air conditioner compressor 76 are operated.

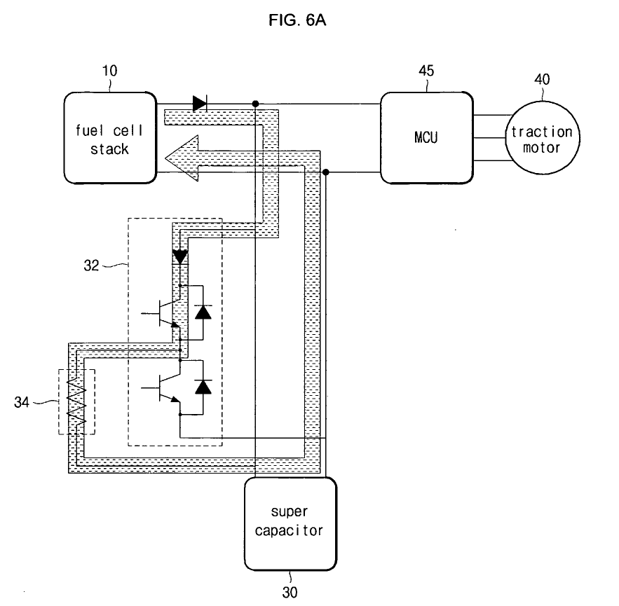

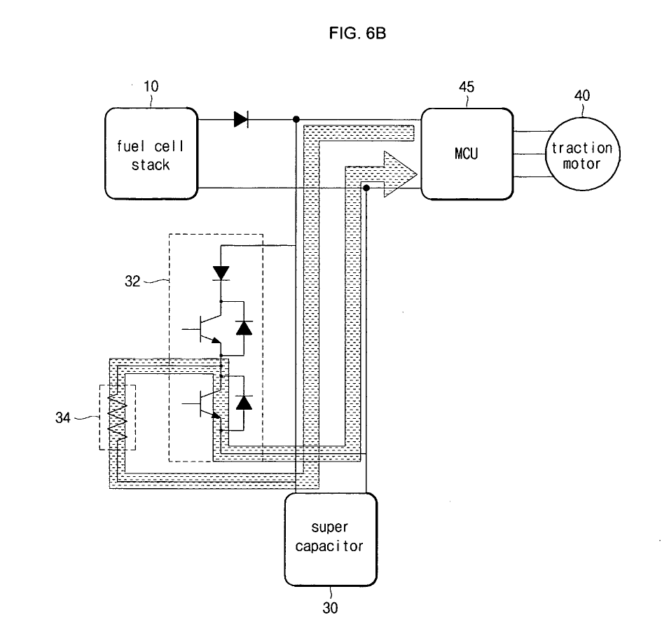

Referring to FIG. 2 and FIG. 3D, in step S80, the super capacitor 30 is charged using the chopper 32 and the braking resistance 34. As described above, the chopper 32 regulates amount of current flowed into the super capacitor 30 so as to prevent the shutdown of the fuel cell stack 10 and damages to the super capacitor 30. FIG. 6A is a drawing showing that the supper capacitor is charged using the chopper 32 and the braking resistance 34.

After the starting mode S1 is performed as described above, in step S90, the hybrid fuel cell bus turns to a hybrid driving mode. The driving mode includes a normal driving mode S2, a hill climbing or acceleration mode S4, and a regenerative braking mode S6.

As the super capacitor 30 is charged, the traction motor 40 can be supplied with electric power from the fuel cell stack 10 and the super capacitor 30 when high load operation is required, e.g., during climbing a hill and acceleration.

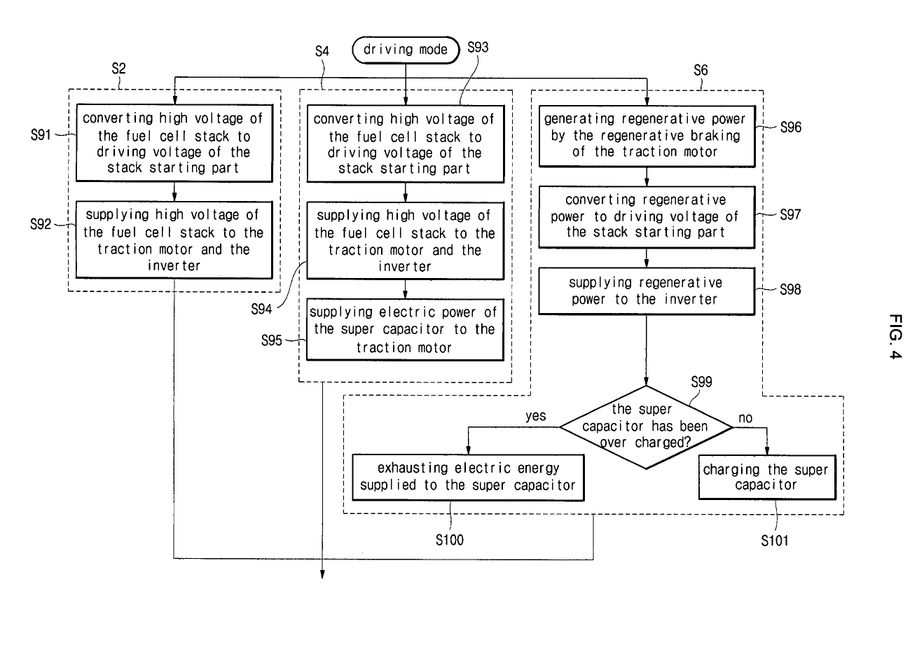

FIG. 4 is a flow chart showing a driving mode in a power system of a hybrid fuel cell bus according to an exemplary embodiment of the present invention. The driving mode includes the normal driving mode S2, a hill climbing or acceleration mode S4, and a regenerative braking mode S6, and has power flow passages according to respective modes.

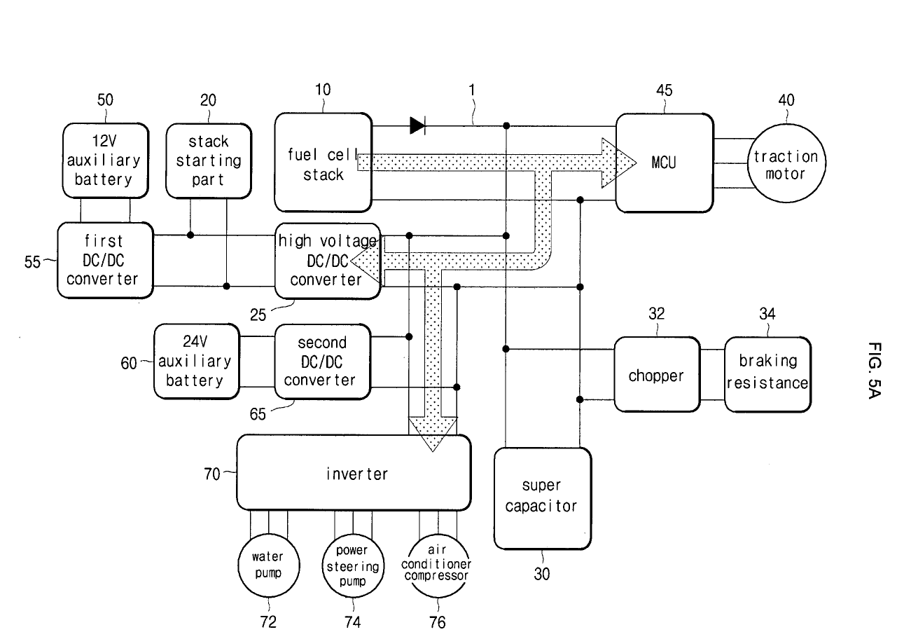

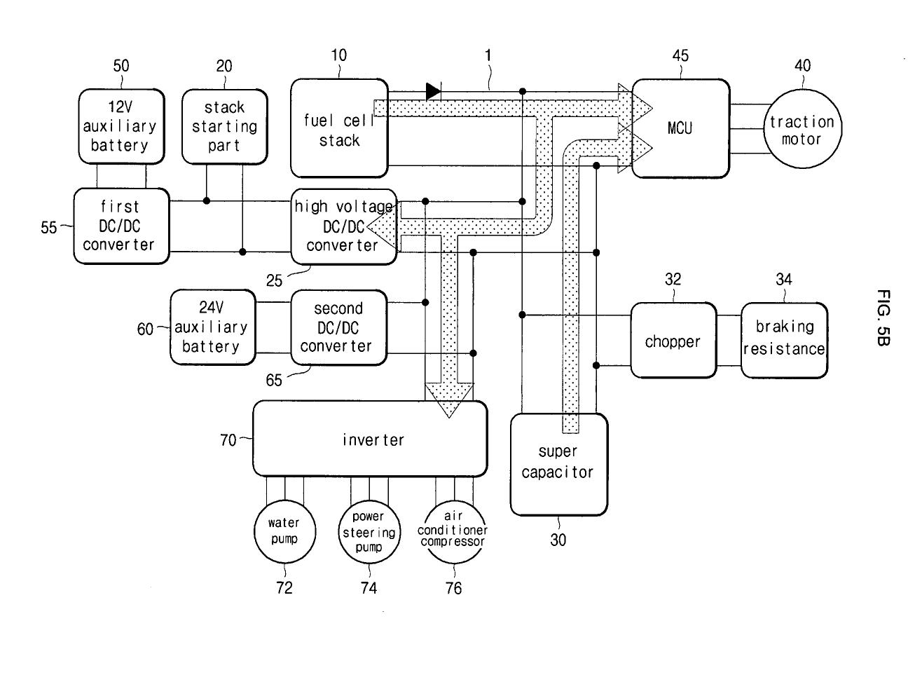

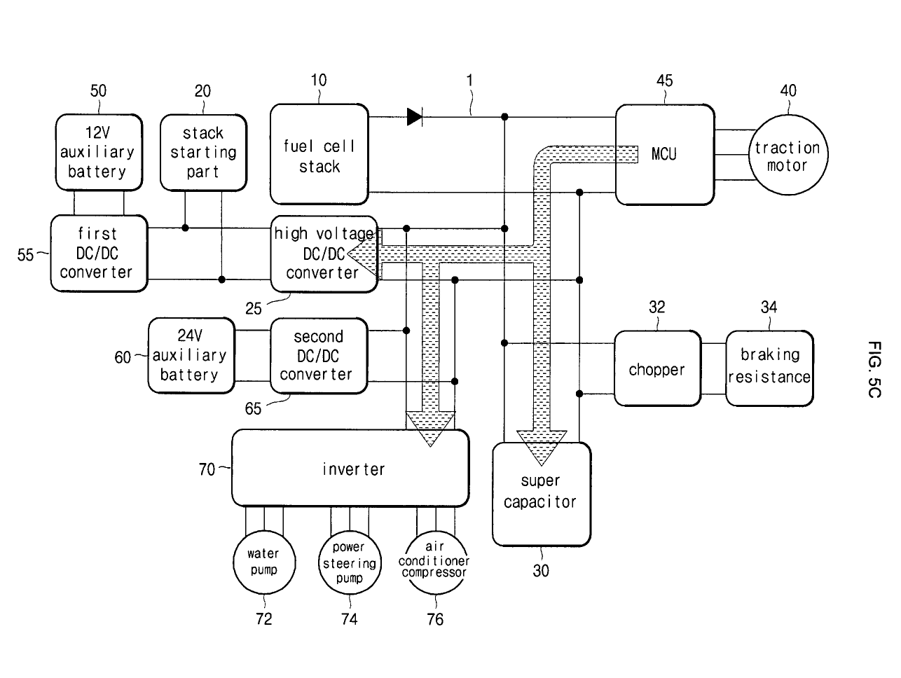

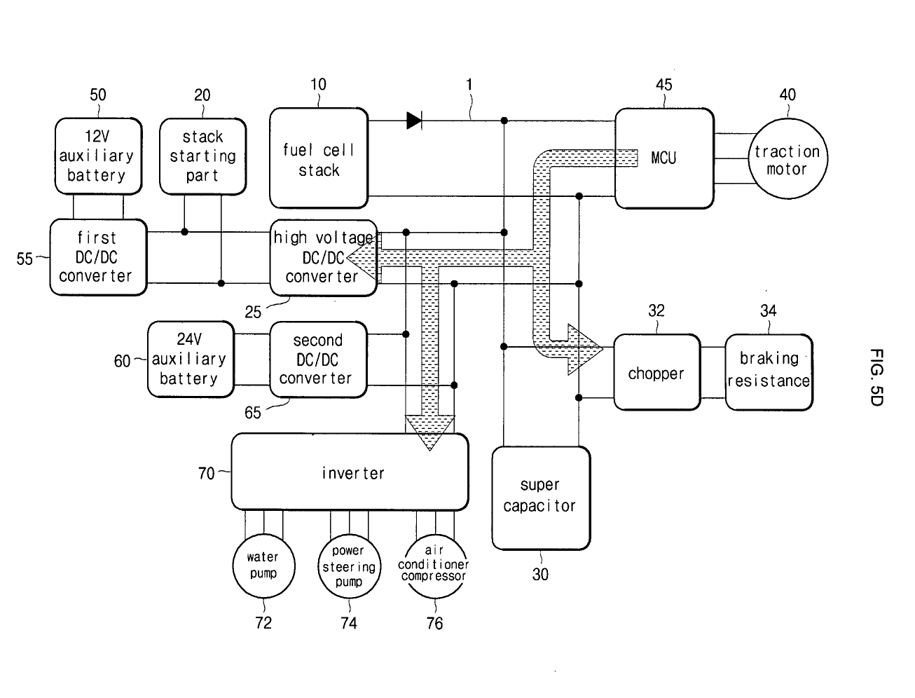

FIG. 5A to FIG. 5D are diagrams showing electric power flows of the driving mode in a power system of a hybrid fuel cell bus according to an exemplary embodiment of the present invention.

Referring to FIG. 4 and FIG. 5A, the normal driving mode S2 includes a step S91 of converting high voltage of the fuel cell stack to driving voltage of the stack starting part, and a step S92 of supplying the high voltage to the traction motor and the inverter.

In the normal driving mode S2, the fuel cell stack 10 provides vehicle driving energy and auxiliary components driving energy. Accordingly, the electric power of the fuel cell stack 10 is supplied to the traction motor 40, the high voltage DC/DC converter 25, and the auxiliary component inverter 70.

At this time, operations of the first and the second DC/DC converters 55 and 65 are controlled depending on the amount of charge of the 12V and 24V auxiliary batteries, and if the 12V and 24V auxiliary batteries need to be charged, the first and the second DC/DC converters 55 and 65 operate so as to charge the auxiliary batteries.

In addition, if the super capacitor 30 needs to be charged, charging of the super capacitor 30 can be performed.

FIG. 5A shows power flows in a state that charges of the 12V and 24V auxiliary batteries 50 and 60 and the super capacitor 30 have been completed.

Referring to FIG. 4 and FIG. 5B, the hill climbing or acceleration mode S4 includes a step S93 of converting high voltage of the fuel cell stack 10 to driving voltage of the stack starting part, a step S94 of supplying the high voltage to the traction motor 40 and the inverter 70, and a step S95 of supplying charge power of the super capacitor 30 to the traction motor 40.

In the case that the traction motor 40 needs to be operated under high load, e.g., in acceleration or climbing a hill, both the fuel cell stack 10 and the super capacitor 30 are used as a power source at the same time. In this regard, the acceleration and hill climbing mode substantially denotes a hybrid mode. Energy stored in the super capacitor 30 is supplied to the traction motor 40 as a power assist. When the energy stored in the super capacitor 30 is supplied to the traction motor 40, the energy is supplied to the traction motor 40 without passing through the chopper 32 and the braking resistance 34.

The operation mode of the acceleration or hill climbing mode S4 and that of the normal driving mode S2 are the same except that the electric power of the super capacitor 30 is supplied to the traction motor 40.

Referring to FIG. 4, FIG. 5C, and FIG. 5D, the regenerative braking mode S6 comprises: a step S96 of generating regenerative power by the regenerative braking of the traction motor 40; a step S97 of converting the regenerative power to the driving voltage of the stack starting parts 20; a step S98 of proving the regenerative power to the inverter 70; a step S99 of determining whether the super capacitor 30 has been over charged; a step S100 of exhausting electrical energy supplied to the super capacitor 30 in the case that the super capacitor is over-charged; and a step S101 of charging the super capacitor 30 by the regenerative power in the case that the supper capacitor 30 is not over-charged.

In the regenerative braking mode S6, the traction motor 40 operates as a generator so as to generate electric power, i.e., regenerative power by the regenerative braking, and this energy is supplied to the stack starting parts 20, the inverter 70 of the auxiliary component, and the super capacitor 3 through the DC power line 1. That is, in the regenerative driving mode, the traction motor 40 is used as a power source.

However, in the case that the super capacitor 30 is over-charged, electric power supply to the super capacitor 30 may cause damages such as shortening of durability of the super capacitor 30.

Accordingly, in step S99, it is determined whether the super capacitor is over-charged. In the case that the super capacitor 30 is not over-charged, that is, in the case that charging is necessary, the super capacitor 30 is charged in step S101. On the other hand, in the case that the super capacitor 30 is over-charged, energy supplied to the super capacitor 30 is exhausted at step S100.

In the case that the super capacitor 30 can be charged, as shown in FIG. 5C, the regenerative power of the traction motor 40 is supplied to the super capacitor 30 so that the super capacitor 30 is charged. In the case that the super capacitor 30 is charged with the regenerative power, the super capacitor 30 is in a state of being partially charged so that there is no abrupt change of energy, so the electric power is supplied without passing through the chopper 32 and the braking resistance 34.

In the case that the super capacitor 30 is over-charged, as shown in FIG. 5D, the electric power generated by the traction motor 40 is exhausted while passing through the chopper 32 and the braking resistance 34. FIG. 6B is a drawing showing that the electric power generated in the traction motor 40 is exhausted while passing through the braking resistance 34 in the case that the super capacitor 30 is over-charged.

The chopper 32 includes two switching transistors and serves as a switch. By regulating current during initial charging of the super capacitor 30 and exhausting the regenerative energy, problems caused by abrupt flowing of current, such as shutdown of a fuel cell stack and damage to the super capacitor, can be prevented. The over-charge of the super capacitor 30 is prevented by such a regulation of energy flow.

By the foregoing configurations, a power system of a hybrid fuel cell bus according to an exemplary embodiment of the present invention can use electrical parts designed for 12V auxiliary battery in fuel cell vehicles, and electric parts designed for 24V auxiliary battery in internal combustion engine vehicles.

Accordingly, electric parts which have been already developed can be used in designing and manufacturing a new hybrid fuel cell bus, and the electric parts can be shared with other vehicles.

As a result, time and costs for developing a hybrid fuel cell bus system can be minimized.

Furthermore, an efficient application of a hybrid system of a super capacitor and a fuel cell can be made to a hybrid fuel cell bus.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A power system of a hybrid fuel cell bus, comprising:
a fuel cell stack;
a super capacitor connected to the fuel cell stack;
a traction motor supplied with electric power from the fuel cell stack or from both the fuel cell stack and the super capacitor so as to drive a vehicle, and supplying electric power generated by regenerative braking to the supper capacitor;
a motor control unit controlling an electric power input to the traction motor and an electric power output from the traction motor;
a first auxiliary battery supplying electric power to first electric parts designed for operation of a fuel cell vehicle;
a second auxiliary battery supplying electric power to second electric parts designed for operation of an internal combustion engine vehicle; and
a stack starting part electrically connected to one of the first and the second auxiliary batteries for operating the fuel cell stack.

2. The power system of claim 1, wherein the first auxiliary battery is a 12V auxiliary battery and the second auxiliary battery is a 24V auxiliary battery.

3. The power system of claim 2, wherein the stack starting part is designed to be supplied with electric power from the first auxiliary battery before starting of the fuel cell stack and is designed to be supplied with electric power from the fuel cell stack after starting of the fuel cell stack.

4. The power system of claim 3, further comprising: a first DC/DC converter between the first auxiliary battery and the stack starting part for converting voltage of the first auxiliary battery to voltage of the stack starting part; and a high voltage DC/DC converter between the fuel cell stack and the stack starting part for converting voltage of the fuel cell stack to voltage of the stack starting part, wherein the high voltage DC/DC converter is electrically connected to the first DC/DC converter such that the voltage converted by the high voltage DC/DC converter is supplied to the first DC/DC converter.

5. The power system of claim 4, wherein the fuel cell stack generates DC voltage of 900V.

6. The power system of claim 4, wherein the driving voltage of the stack starting part is 350V.

7. The power system of claim 4, wherein a second DC/DC converter is provided between the fuel cell stack and the second auxiliary battery so as to charge the second auxiliary battery using electric power of the fuel cell stack.

8. The power system of claim 2, wherein an inverter is electrically connected to the fuel cell stack for being supplied with electric power of the fuel cell stack to drive an auxiliary component.

9. The power system of claim 8, wherein the auxiliary component comprises at least one selected from the group consisting of a water pump, a power steering pump, and an air conditioner compressor.

10. The power system of claim 2, further comprising a power line electrically connecting the fuel cell stack and the traction motor and a power line passing through a chopper and a braking resistance provided in a power line connecting the super capacitor.

11. The power system of claim 10, wherein the power lines are configured such that electrical energy supplied to the super capacitor is exhausted when the super capacitor is over-charged and electric power regenerated by the traction motor is charged to the super capacitor when the super capacitor is not over-charged.

12. A control method of a power system of a hybrid fuel cell bus including a first auxiliary battery and a second auxiliary battery, comprising the steps of:
(a) converting a low voltage of a first auxiliary battery to a driving voltage of a stack starting part;
(b) driving the stack staring part by the driving voltage of the stack starting part;
(c) operating a fuel cell stack by operation of the stack starting part;
(d) generating a high voltage power by operation of the fuel cell stack;
(e) switching an electric power supply passage to the stack starting part so as to convert the high voltage power to the voltage of the stack starting part, and supplying the converted voltage to the stack starting part;
(f) supplying the high voltage power to a traction motor;
(g) converting the high voltage power to the voltage of the first auxiliary battery; and
(h) charging a super capacitor with the high voltage power.

13. The control method of claim 12, wherein the step (a) further comprises a step where the first auxiliary battery supplies electric power to first electric parts designed for operation of a fuel cell vehicle and the second auxiliary battery supplies electric power to second electric parts designed for operation of an internal combustion engine vehicle.

14. The control method of claim 13, wherein the first auxiliary battery is a 12V auxiliary battery and the second auxiliary battery is a 24V auxiliary battery.

15. The control method of claim 13, wherein the step (a) and the step (g) comprise a DC/DC converter.

16. The control method of claim 13, wherein the step (e) converts 900V to 350V.

17. The control method of claim 13, wherein the step (e) or (f) further comprises a step of converting the high voltage power generated by the fuel cell stack to a low voltage so as to charge the second auxiliary battery.

18. The control method of claim 13, wherein the step (g) further comprises a step of supplying the high voltage power to an inverter of an auxiliary component.

19. The control method of claim 13, further comprising a step of performing a driving mode after the step (h), wherein the driving mode is one selected from the group consisting of:
a normal driving mode which comprises the steps of: converting high voltage of the fuel cell stack to driving voltage of the stack starting part; and supplying the high voltage to the traction motor and the inverter;
an acceleration or hill climbing mode which comprises the steps of: converting high voltage of the fuel cell stack to driving voltage of the stack starting part; supplying the high voltage to the traction motor and the inverter; and supplying charged electric power of the super capacitor to the traction motor; and
a regenerative braking mode which comprises the steps of: generating regenerative electric power by regenerative braking of the traction motor; converting the regenerative electric power to the driving voltage of the stack starting part; supplying the regenerative electric power to an inverter; determining whether the super capacitor has been over charged; exhausting electrical energy supplied to the super capacitor when the super capacitor is over-charged; and charging the super capacitor by the regenerative electric power when the super capacitor is not over-charged.
